(19) United States
(12) Patent Application Publication
(10) Pub. No.: US 2026/0264994 A1
(43) Pub. Date: Sep. 10, 2026

(54) STACKING COLUMN FOR STORING GOODS

(71) Applicant: MTS Maschinenbau GmbH, Mengen (DE)

(72) Inventor: Eckhard LAIBLE, Leinfelden-Schlechtenmühle (DE)

(73) Assignee: MTS Maschinenbau GmbH, Mengen (DE)

(21) Appl. No.: 19/557,353

(22) Filed: Mar. 5, 2026

(30) Foreign Application Priority Data
Mar. 5, 2025 (DE) 10 2025 108 269.3

(51) Int. Cl. B65G 1/14

(52) U.S. Cl. CPC B65G 1/14

(57) ABSTRACT

A stacking column for holding bearing parts on a stacking pawl (1) includes a base body (2) consisting of two side walls (3, 4) connected to each other via a rear wall (5), the two side walls (3, 4) form a channel shape with the rear wall (5), the stacking pawls (1) are arranged between the two side walls (3, 4) in the channel shape, the stacking pawls (1) are arranged so that they can pivot one above the other, each of the stacking pawls (1) is assigned an axle bolt (6) and a linkage bolt (7), wherein the linkage bolt (7) is movably guided within two arcuate elongated holes (8.1, 8.2), wherein the arcuate elongated holes (8.1, 8.2) are each embedded in one of the side walls (3, 4), and the axle bolt (6) is rotatably mounted between the two side walls (3, 4) and in bores (9.1, 9.2) of the side walls (3, 4), a return spring (10) being arranged around the axle bolt (6), the first spring leg (11.1) of which presses against the rear wall (5) and the second spring leg (11.2) of which is arranged to push the linkage bolt (7) back to a rest position, a radial spring connects the linkage bolt (7) and the axle bolt (6) and is arranged to pull the linkage bolt (7) towards the axle bolt (6), thereby pulling the linkage bolt (7) towards an inner contour (13) of the arched elongated holes (8.1, 8.2) facing the axle bolt (6), wherein the stacking pawl (1) has a pawl finger (21) and a guide receptacle (22), wherein the pawl finger (21) is pivotably mounted to the guide receptacle (22) via a pivot pin (15).

### BACKGROUND OF THE INVENTION

The invention relates to a stacking column for storing goods.

Such stacking columns are already known and in use in a variety of forms and designs. For example, DE 20 2009 002 432 U1 discloses a stacking column that is used to store car body parts, which are placed at a distance from each other between several stacking columns. When a car body part is inserted, a first latch automatically swings into the working position so that the support arm of the first latch picks up the part. A linkage moves the second latch above it into the standby position, while the latches above it remain in the rest position. Since in some applications several car body parts are stacked on top of each other on the same latch and unloaded individually, empty latches could hinder the unloading process. To prevent this, the support arm of the latch is connected to the support part of the latch by a joint and can be swung out independently so that it is outside the access area of the car body part. The manufacturing costs of the individual latches are higher, as they are made up of more individual components. For example, the latches in the document require a stop on a rear wall.

### SUMMARY OF THE INVENTION

The purpose of the present invention is to overcome the disadvantages of the prior art. In particular, a stacking column is to be provided which holds several stored goods stacked on top of or inside each other on a latch and which can also be removed from the support arm of the latch one after the other during individual unloading.

The features disclosed herein solve the task.

Advantageous embodiments are also described herein and in the subclaims.

The stacking column according to the invention for holding stored goods on a single stacking pawl is designed in such a way that the stacking pawl is moved from a rest position to a standby position. In order to place stored goods on top of or next to each other at defined intervals on a stacking pawl, several stacking pawls are used, which are arranged either on top of or next to each other. These stacking pawls are mounted in a swiveling manner within the channel shape between the two side walls.

The stacking clamps are connected to each other via a linkage that engages with the linkage bolt. The linkage ensures that the movement of a stacking clamp is controlled: as soon as a stacking clamp reaches the working position, i.e., is loaded, the adjacent stacking clamp is moved from the rest position to the standby position. The standby position indicates that the stacking pawl is ready for the next item to be stored.

The stacking clamps are moved by the linkage, which controls their position between the rest position, standby position, and working position. The linkage is connected to the linkage bolt. The first or lowest stacking pawl is an exception, as it is not usually in a rest position, but only switches between the standby position and the working position. It is located directly on the base plate and always remains in one of these two positions.

Previously, it was common practice to place stored goods on a stacking pawl in a single loading process. Multi-stage loading, in which several stored goods are placed one after the other on a single stacking pawl, was not possible. However, this was not the most efficient approach, as in practice stored goods are often produced one after the other or removed from a manufacturing machine and then deposited.

The stacking column according to the invention now enables a multi-stage loading process. This allows several stored goods to be placed on a single stacking pawl. This is regardless of whether they belong together functionally or not.

The stacking column consists of a base body with two side panels connected by a rear wall. The stacking clamps are mounted between the two side panels on a pivot pin so that they can rotate. These side panels form a channel shape with the rear wall, which can optionally include a base plate. The base plate can be fixed to a surface, for example, the floor of a factory hall, a storage trolley, or a pallet.

Each stacking pawl has a linkage bolt that can move within a straight or curved slotted hole in the side panel. This allows the stacking pawl to move in a defined manner. The linkage controls the movement between the rest, standby, and working positions. In the embodiment described in, the linkage bolt is guided within two curved slotted holes, each of which is embedded in the side plates. The axle bolt, in turn, is mounted between the side plates and rotates within corresponding bores.

A return spring is arranged around the axle bolt to reset the stacking pawl. Its first spring leg presses against the rear wall, while its second spring leg returns the linkage bolt to its rest position. This means that the return spring uses its force to press the stacking pawl into the rest position, while the weight of the stored goods exerts an opposite force on the stacking pawl.

In addition to a linkage bolt, each stacking pawl also has an axle bolt. These bolts are not part of the stacking pawl itself, but serve its function.

A significant innovation of the invention is the use of a radial spring that connects the linkage bolt to the axle bolt. This radial spring pulls the linkage bolt toward the axle bolt and at the same time ensures that the linkage bolt is constantly pressed against the inner contour of the arched slots. This enables controlled movement of the linkage bolt and thus also of the stacking pawl.

Particularly noteworthy is the special design of the stacking pawl, which consists of two central components: the pawl finger and the guide mount. These two elements are connected to each other in a pivotable manner via a hinge pin. This allows the pawl finger to move independently while still being held securely in the guide mount. A key feature of this design is that, once the stacking pawl has been completely discharged, the pawl finger automatically swings back into its rest position under its own weight. However, it is not only the pawl finger itself that moves back, but the entire stacking pawl swings back into its rest position under the combined effect of gravity and the forces acting on it. This mechanism ensures reliable and trouble-free operation, as no additional mechanical or electrical reset mechanisms are required.

A particular advantage of this design is evident above all in the selective unloading of individual stored goods, especially when several stored goods are located on a single stacking pawl. Without the swiveling mounting of the pawl finger, the stacking pawl above could significantly impede or even block the unloading process. This is because it is in the standby position and protrudes from the base body while the stacking pawl below is being unloaded. In a conventional system, this would mean that the upper pawl would have to be moved manually or by a separate mechanism in order to remove the stored goods below without obstruction.

However, the swivel mounting of the pawl finger within the guide holder elegantly solves this problem. As soon as a stored item is removed from the lower stacking pawl, the pawl finger of the stacking pawl above can automatically swing back into the base body. This prevents the upper stacking pawl from obstructing the unloading process. Once the stored goods have been completely removed and passed the upper pawl, the pawl finger swings back into the standby position automatically due to its design and its own weight. This enables continuous and smooth removal of the stored goods without the need for manual intervention or additional mechanisms.

In summary, this design ensures high efficiency and user-friendliness when handling stacked stored goods. The automatic return of the pawl finger and the entire stacking pawl to their starting position ensures optimized material flow, reduces potential disruptions during unloading, and makes handling much easier. This makes the system particularly suitable for applications where fast, easy, and trouble-free removal of stored goods is required.

The pawl finger may have a finger spring arranged to pull the pawl finger toward the rear wall. In addition to its own weight, this creates an additional possibility for the pawl finger to swing back from the standby position to the rest position. This can be done in a more controlled and, if necessary, faster manner thanks to the finger spring.

The wings each have a hinge pin bore, with the hinge pin being pivotably mounted in and between the wings. The hinge pin bore is recessed into the wings in such a way that the linkage pin is arranged between the axle pin and the hinge pin, whereby the axle bolt of the stacking pawl is arranged towards the rear wall in the installed position and the hinge bolt is arranged away from the rear wall in the area of the wings, so that the linkage bolt is located between the axle bolt and the hinge bolt as described.

The guide receptacle also forms a support strip under the pawl finger. Under the pawl finger, the side of the guide receptacle to which the pawl finger does not pivot during proper use, but rather pivots away to the rest position. Consequently, the guide receptacle forms the support strip in the working position away from the rear wall.

It is crucial for the function that the inner contour of the arched elongated holes between the rest position and the working position of the stacking pawl has an interruption in the course for the linkage bolt. One possible design of the interruption in the course can be a overcoming bead, which protrudes from the axle bolt as a raised part. However, it can also be a step that divides the course of the inner contour into two sections. A first section away from the rest position to the interruption in the course and a second section from the interruption in the course to the working position. For example, the first section runs closer to the axle bolt and the second section rises and runs further away from the axle bolt. In addition, the interruption in the contour can also be a recess or recess pocket into which the linkage bolt moves toward the axle bolt and out of again after overcoming the interruption in the contour. Hybrid forms of this are also possible.

The interruption in the contour may also be a bead that is further away from the axle bolt than the rest of the inner contour (when viewed from the side on one of the side walls). However, by definition, a protruding bead is also present if there is a recessed pocket between the rest position and the working position that is drawn toward the axle bolt, into which the linkage bolt enters in the standby position, briefly stops, and then continues into the working position after the stacking pawl has been sufficiently loaded.

This interruption in the curve interrupts the arched curve of the inner contour and enables multi-stage loading of the stacking pawl. In combination with the radial spring, which always presses the linkage bolt against the inner contour, the interruption in the curve acts as an obstacle to be overcome. This obstacle is overcome as soon as a defined load acts on the stacking pawl.

The multi-stage loading process results from the fact that the obstacle of the progression interruption is only overcome when the previously specified weight of the stored goods is reached. Only when the force exerted on the stacking pawl exceeds the defined force of the radial spring does the linkage bolt slide over the progression interruption and change from the standby position ( ) to the working position. At the same time, the next stacking pawl is moved from the rest position to the standby position.

The progression interruption is arranged within the inner contour between a rest position recess and a working position recess.

In an alternative embodiment, the second spring leg of the return spring can protrude between the linkage bolts and the stacking pawl.

The inner contour of the arched elongated hole has a predominantly arched distance of 15 mm to 85 mm from the axle bolt holes. The curved path begins at the hole in the side wall into which the axle bolt engages, shortly after the 12 o'clock position, and ends between the 4:00 and 5:30 positions in relation to this hole.

This progression corresponds to the typical pattern of the arc-shaped elongated hole and thus also to the inner contour. However, it is interrupted, for example, by the overcoming bead, which has a larger radial distance from the axle bolt hole. Apart from the overcoming bead, the inner contour can have a basic radial distance of 15 mm to 85 mm. This allows the designer to determine, depending on the distance, how much weight is required to guide the rod bolt over the overcoming bead. A greater distance requires greater force and thus a higher weight of the stored goods.

In addition, the force required to overcome the interruption in the progression can be adjusted by using several radial springs. There may be an additional radial spring which, together with the first radial spring, flanks the return spring at the ends of the axle bolt. This ensures even force distribution and prevents long-term unilateral loads on the axle bolt or the linkage bolt.

In addition, further interruptions in the contour may be formed on the inner contour in addition to the one interruption. This gives the designer the opportunity to specifically calculate and control multi-stage loading processes.

One possible embodiment of a stacking pawl according to the invention consists of a pawl finger and a guide receptacle. The guide receptacle consists of a base area and two wings arranged at right angles, each of which has two axle bolt holes and two guide bolt slots. In addition, two guide bolt slots are formed parallel to a bend in the base area that transitions to the wings. The pawl finger may also be provided with an additional plastic coating.

### BRIEF DESCRIPTION OF THE DRAWINGS

Further advantages, features, and details of the invention are apparent from the following description of preferred embodiments and from the drawings, which show in:

FIG. 1 shows a perspective view of a stacking column from an oblique top view.

FIG. 2 shows a partial perspective view of the stacking column from FIG. 1 from a first perspective.

FIG. 3 shows the partial view of FIG. 1 from a second perspective.

FIG. 4 shows a partial view of one of the side walls.

FIG. 5 shows a partial view of the side panel from FIG. 4 without any other components.

FIG. 6 shows a partial side view of another stacking column in a first loading stage.

FIG. 7 shows the partial side view from FIG. 6 in a second loading stage.

FIG. 8 shows the partial side view from FIG. 6 in a first unloading stage.

FIG. 9 shows the partial side view from FIG. 6 in a second unloading stage.

FIG. 10 shows the partial side view of another stacking column in a first loading stage.

FIG. 11 shows the partial side view from FIG. 10 in a second loading stage.

FIG. 12 shows the partial side view from FIG. 10 in a first discharge stage.

FIG. 13 shows the partial side view from FIG. 10 in a second discharge stage.

### DETAILED DESCRIPTION

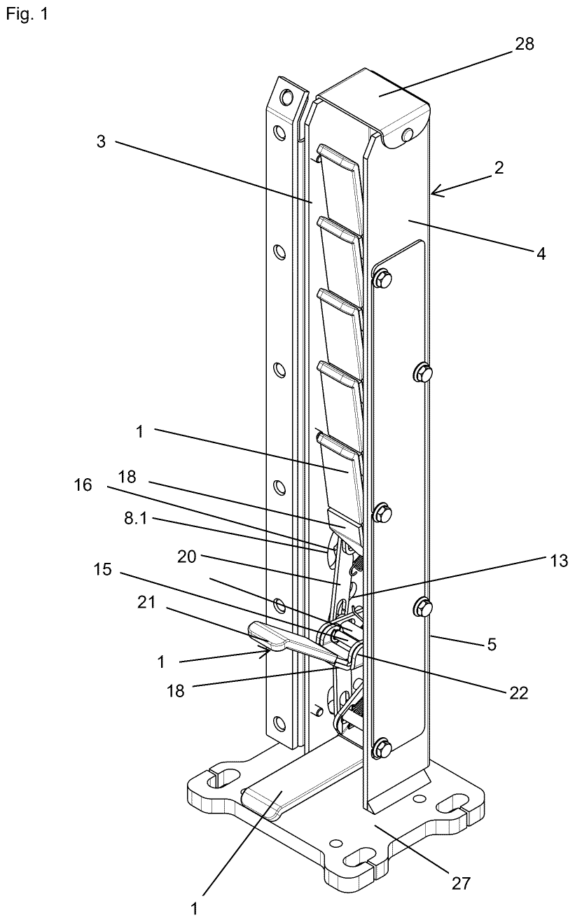

FIG. 1 shows a perspective view of a stacking column from an oblique angle above. The stacking column is used to hold storage parts on a stacking pawl 1, wherein a base body 2 consists of two side walls 3, 4, which are connected to each other via a rear wall 5, wherein the two side walls 3, 4 form a channel shape with the rear wall 5. The base body 2 has a base plate 27 at one end and an end plate 28 at the other end.

The stacking clamps 1 can assume different positions. When the stacking clamp 1 is not loaded and is not to be loaded, it is in the rest position and is held in the base body 2.

When the stacking pawl 1 shown in the example here is to be loaded, it swivels out of the base body 2 at an angle of less than 90 degrees and can then hold the stored goods to be accommodated until it slides into the working position, whereby the stacking pawl 1 is arranged at essentially 90 degrees to the base body in the area accommodating the stored goods.

The stacking clamps 1 are arranged between the two side walls 3, 4 in a channel shape so that they can pivot one above the other. The first stacking clamp 1, which is closest to the base plate 27, has the special feature that in the initial situation it is not in the rest position but in the standby position.

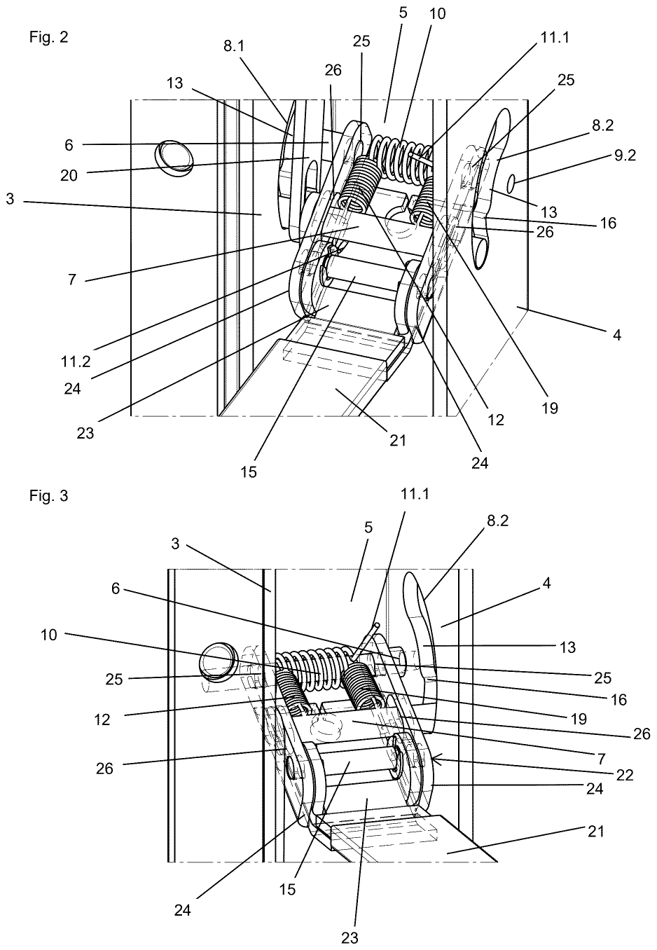

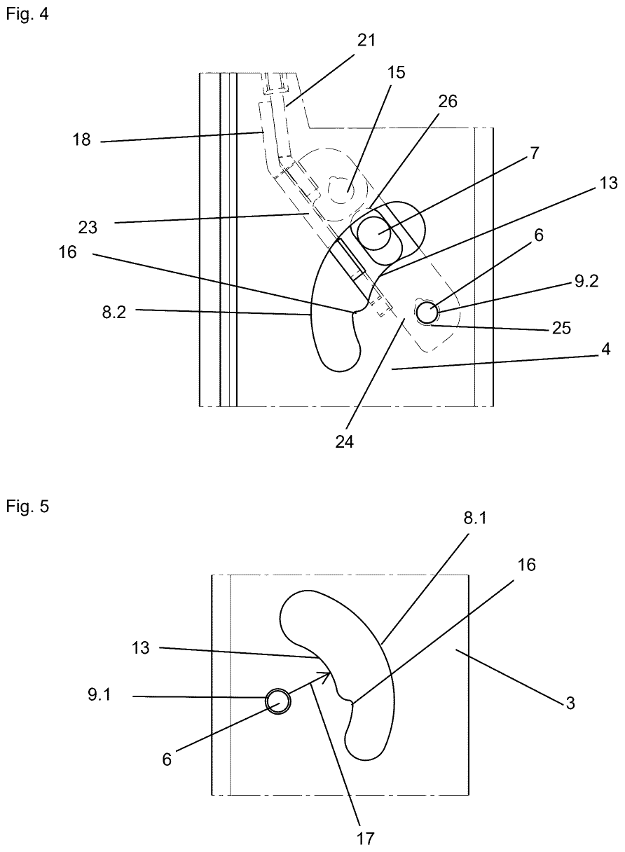

Each stacking pawl 1 is assigned an axle bolt 6 and a linkage bolt 7. This can be seen particularly well in FIGS. 2 to 9.

The linkage bolt 7 is movably guided within two arched elongated holes 8.1, 8.2, whereby the arched elongated holes 8.1, 8.2 are each embedded in one of the side cheeks 3, 4. FIG. 1 shows how the arched elongated hole 8.1 and the side cheek 3 are embedded. The other figures also show that the curved elongated hole 8.2 is embedded in the side wall 4. The two curved elongated holes always form the respective mirror image of the other curved elongated hole 8.1, 8.2.

Furthermore, the axle bolt 6 is rotatably mounted between the two side cheeks 3, 4 and in bores 9.1, 9.2 of the side cheeks 3, 4. The bore 9.1 is embedded in one side cheek 3 and the bore 9.2 in the other side cheek 4. The details can be seen in FIGS. 2 to 9.

As can be clearly seen in FIGS. 2 and 3, a return spring 10 is arranged around the axle bolt 6, the first spring leg 11.1 of which presses against the rear wall 5 and the second spring leg 11.2 of which is arranged to push the linkage bolt 7 back to a rest position. The spring legs 11.1, 11.2 are shown partially in dashed lines in the other figures, as the corresponding side walls 3, 4 have been shown partially transparent. The second spring leg 11.2 protrudes (visible in various figures) between the linkage bolt 7 and the stacking pawl 1.

In the embodiment shown here, FIGS. 2 and 3 also show two radial springs 12, 19 connecting the linkage bolt 7 and the axle bolt 6. The radial springs 12, 19 are arranged in such a way that they pull the linkage bolt 7 toward the axle bolt 6. In turn, they pull the linkage bolt 7 toward an inner contour 13 of the arched elongated holes 8.1, 8.2 facing the axle bolt 6. This results in a controlled movement of the linkage bolt 7 along the inner contour 13 of the arched elongated holes 8.1, 8.2. The radial spring 12 and the additional radial spring 19 are arranged such that the radial spring 12 and the additional radial spring 19 flank the return spring 10 at the axle bolt 6 at each end. Details of this can be seen in FIGS. 2 and 3.

FIGS. 2 and 3 also show that the stacking pawl 1 consists of a pawl finger 21 and a guide receptacle 22, whereby the pawl finger 21 is pivotably mounted to the guide receptacle 22 via a pivot pin 15. The guide mount 22 ensures that the movements of the stacking pawl 1 can be carried out within the base body 2. For this purpose, the guide mount 22 has functional connecting elements to the axle bolt 6, the linkage bolt 7, and a linkage 20 that moves the linkage bolt 7. The stacking pawls 1 are connected to each other via the linkage 20, engaging with the linkage bolt 7. The linkage 20 is shown in FIGS. 1 and 2.

The pawl finger 21 serves to receive the stored goods and hold them until they are removed.

The pivot pin 15, in turn, has the task of ensuring that the pawl finger 21 is pivotally arranged relative to the guide receptacle 22. This means that, due to the pivot pin 15, the pawl finger 21 can, at least to a limited extent, assume a different direction than that which the guide pin 22 would dictate in the case of a rigid connection.

The guide mount 22, in turn, consists of a base area 23 and two wings 24 arranged at right angles, whereby the wings 24 have two axle bolt holes 25 and two guide bolt slots 26. The two guide bolt slots 26 are formed parallel to a bend in the base section 23 towards the wings 24. The wings 24 each form a pivot pin hole, whereby the pivot pin 15 is pivotably mounted in and between the wings 24.

The guide receptacle 22 forms a support strip 18 as an extension of the base away from the rear wall 5, which runs under the latch finger 21. However, if the latch finger 21 were to fold in a different direction than that specified by the guide receptacle 22, the latch finger 21 would lift away from the support strip 18.

The support strip 18 primarily serves to stabilize the entire stacking pawl 1 during loading and also prevents the pawl finger 21 from folding down uncontrollably if, for example, the pivot pin 15 is designed as a freely rotating axis. In an embodiment not shown, the pivot pin 15 can be held or influenced by a finger spring. In such a case where a finger spring is present, the pawl finger 21 would have the finger spring arranged in such a way as to pull the pawl finger 21 towards the rear wall 5, for example.

The embodiment shown in FIGS. 1 to 5 has a special feature in the shape of the inner contour 13. In the embodiment shown, between the rest position of the stacking pawl 1 and a working position of the stacking pawl 1, there is a break in the contour 16 protruding from the axle bolt 6, which is designed as an overcoming bead. The interruption 16 in the course of the contour represents an obstacle for the linkage bolt 7 sliding along the inner contour 13, whereby the interruption 16 in the course of the contour is only overcome when a certain weight acts on the stacking pawl 1. This can also be achieved by placing not a single part with a specific overcoming weight on the stacking pawl 1, but several parts which only reach the overcoming weight when taken together. In this way, it is advantageously possible to load the stacking pawl with several components, and if necessary also one after the other, i.e. also with different components.

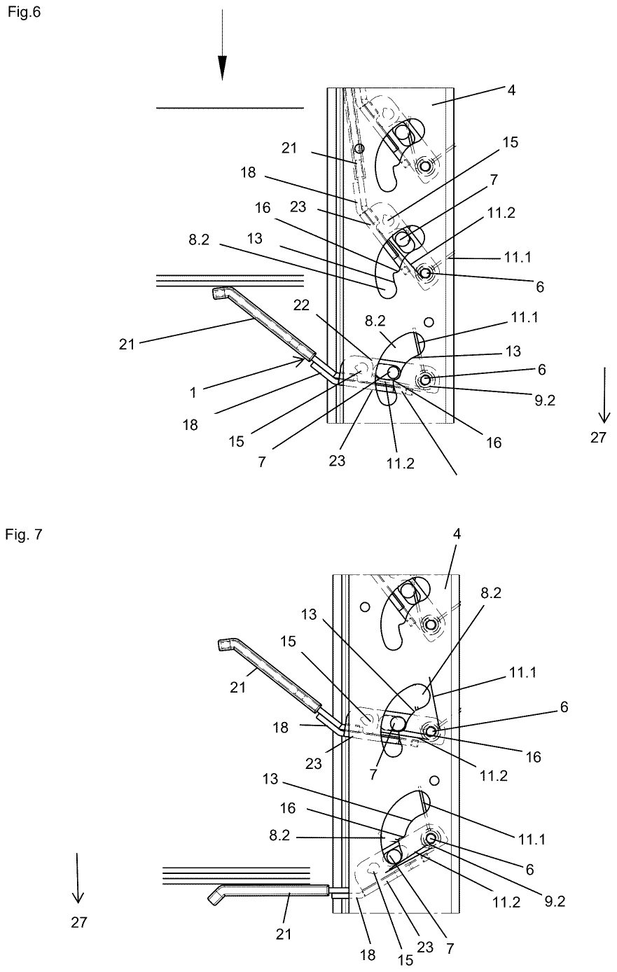

FIG. 5 shows that the inner contour 13 has an essentially arcuate distance 17 of 15 mm to 85 mm from the boreholes 9.1 of the axle bolt 6. This also applies to the embodiment in FIGS. 6 to 9.

FIGS. 6 to 9 show the embodiment from FIGS. 1 to 5, which has the interruption 16 in the inner contour 13. This embodiment has the advantage, for example, that although several bearing parts can be loaded onto the stacking pawl 1 at once, they can still be unloaded individually.

In practice, problems repeatedly arose when, for example, too many bearing parts lying on top of or inside each other had to be lifted individually. The greater the number of bearing parts, the more frequently more than one bearing part is unintentionally lifted when lifting. This is due to the fact that, for example, a suction cup effect or surface adhesion can occur, or if liquids are present between the individual bearing parts, the capillary forces caused by oil or water, for example, between the bearing parts can lead to the unwanted lifting of not only one bearing part, but several bearing parts at once.

However, if only a certain smaller number of bearing parts are held per stacking pawl 1, it is easier to lift the bearing parts individually.

FIG. 6 shows a partial side view of the stacking column in a first loading stage. There, the first stacking pawl 1 facing the base plate 27 is in the standby position. The first stacking pawl 1 already has three bearing parts, with a fourth bearing part being fed in.

FIG. 7 shows the partial side view from FIG. 6 in a second loading stage. There, the first stacking pawl 1 is now in the working position and the second stacking pawl 1, which is arranged above it on the base plate 27, has been swung out of the base body 2 for loading and is in the standby position. During the transition from the first to the second loading stage, the linkage bolt 7 of the first stacking pawl 1 has passed the interruption 16 and has slid into the end position in the direction of the base plate 17. The second stacking pawl 1 has again slid into the standby position, so that the linkage bolt 7 of the second stacking pawl 1 now rests against the interruption 16.

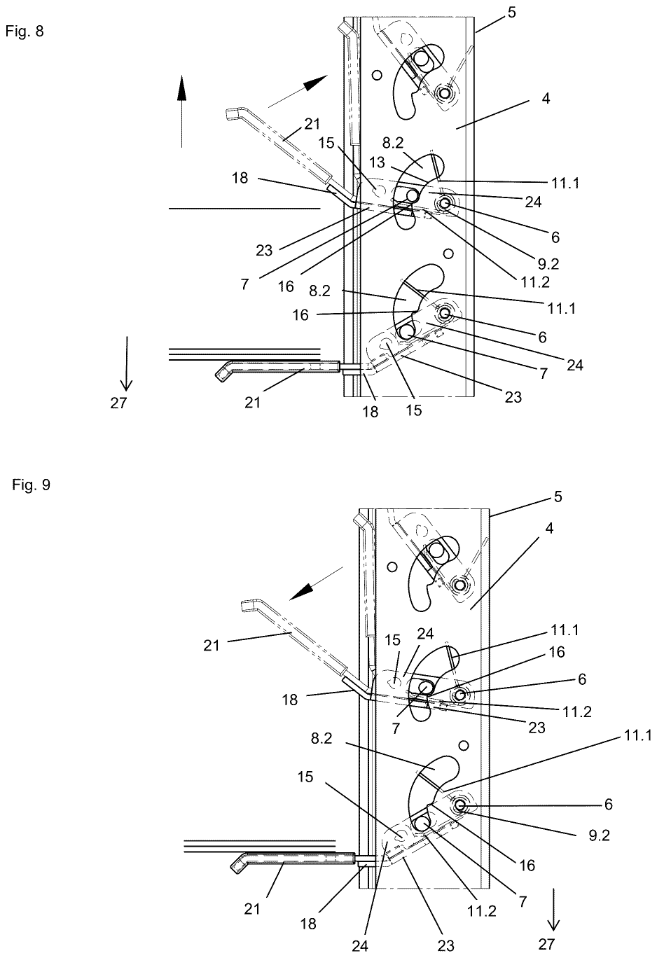

FIG. 8 again shows the partial side view from FIG. 6 in a first unloading stage. In the first unloading stage, the topmost bearing part is now lifted away again by the first stacking pawl 1. The second stacking pawl 1 located above it would actually remain in the standby position. However, due to the interaction of the pivot pin 15 with the pivot finger 21, it is now possible for the pivot finger 21 to pivot away from the base plate 27 without the rest of the second stacking pawl 1, in particular the guide receptacle 22, having to leave the standby position. Nevertheless, in the position shown away from the base plate 27, the hinge finger 21 does not interfere with the unloading process of the first stacking pawl 1 located below.

FIG. 9 shows the partial side view from FIG. 6 in a second unloading stage in which the articulated finger 21 of the second stacking pawl 1 swivels back into the standby position and thus also rests again on the support strip 18. Consequently, the second stacking pawl 1 is again in the standby position overall.

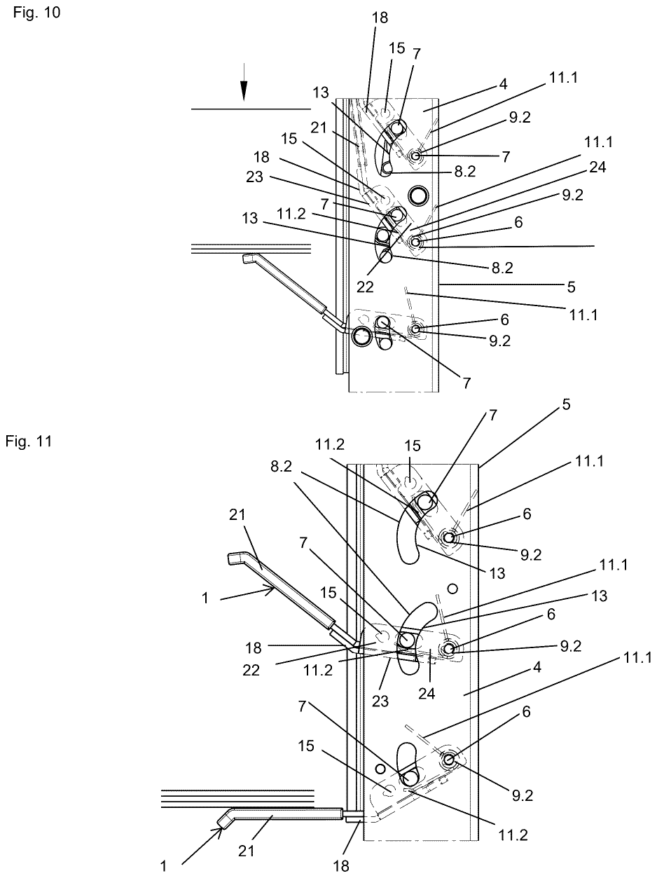

FIGS. 10 to 13 show an embodiment that does not have a break 16 in the inner contour 13. This embodiment has the advantage, for example, that although several bearing parts can be loaded onto the stacking pawl 1 at once, they can still be unloaded individually.

In practice, problems repeatedly arose when, for example, too many bearing parts lying on top of or inside each other had to be lifted individually. The greater the number of bearing parts, the more frequently more than one bearing part is unintentionally lifted when lifting. This is due to the fact that, for example, a suction cup effect or surface adhesion can occur, or if liquids are present between the individual bearing parts, the capillary forces caused by oil or water, for example, between the bearing parts can lead to the unwanted lifting of not only one bearing part, but several bearing parts at once.

However, if only a certain smaller number of bearing parts are held per stacking pawl, it is easier to lift the bearing parts individually.

FIG. 10 shows a partial side view of the stacking column in a first loading stage. The first stacking pawl 1 pointing towards the base plate 27 is in the standby position. The first stacking pawl 1 already has three bearing parts, with a fourth bearing part being fed in.

FIG. 11 shows the partial side view from FIG. 10 in a second loading stage. There, the first stacking pawl 1 is now in the working position and the second stacking pawl 1, which is arranged above it away from the base plate 27, has been swiveled out of the base body 2 for loading and is in the standby position.

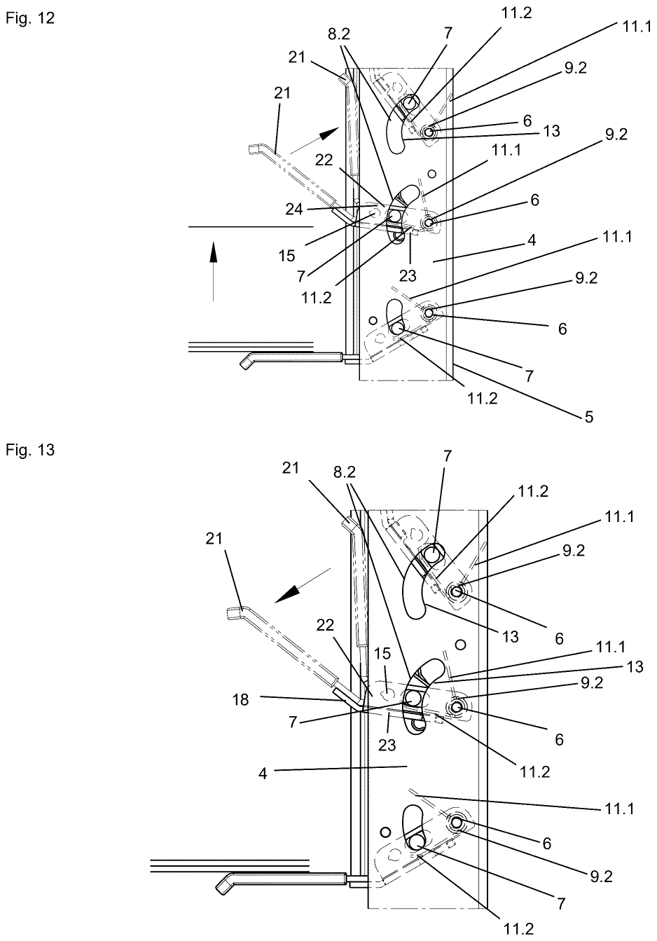

FIG. 12 again shows the partial side view from FIG. 10 in a first unloading stage. In the first unloading stage, the topmost bearing part is now lifted away again by the first stacking pawl 1. The second stacking pawl 1 located above it would actually remain in the standby position. However, due to the interaction of the pivot pin 15 with the pivot finger 21, it is now possible for the pivot finger 21 to pivot away from the base plate 27 without the rest of the second stacking pawl 1, in particular the guide receptacle 22, having to leave the standby position. Nevertheless, in the position shown away from the base plate 27, the hinge finger 21 does not interfere with the unloading process of the first stacking pawl 1 located below.

FIG. 13 shows the partial side view from FIG. 10 in a second unloading stage in which the articulated finger 21 of the second stacking pawl 1 swivels back into the standby position and thus also rests on the support strip 18 again. Consequently, the second stacking pawl 1 is again in the standby position overall.

List of reference symbols

| | |
|---|---|
| 1 | Stacking pawl |
| 2 | Base body |
| 3 | First side plate |
| 4 | Second side panel |
| 5 | Rear panel |
| 6 | Axle bolt |
| 7 | Linkage pin |
| 8 | Arc slot |
| 9 | Bore |
| 10 | Return spring |
| 11.1, 11.2 | Spring strut |
| 12 | Radial spring |
| 13.1, 13.2 | Inner contour |
| 14 | Radial distance |
| 15 | Pivot pin |
| 16 | Interruption of continuity |
| 17 | Distance |
| 18 | Support strip |
| 19 | Additional radial spring |
| 20 | Linkage |
| 21 | Lever finger |
| 22 | Guide mount |
| 23 | Bottom area |
| 24 | Wing |
| 25 | Axle bolt hole |
| 26 | Guide bolt slot |
| 27 | Base plate |
| 28 | End plate |
| 29 | |
| 30 | |
| 31 | |
| 32 | |
| 33 | |

What is claimed is:

1. Stacking column for holding bearing parts on a stacking pawl (1), comprising:
a base body (2) having two side walls (3, 4) connected to each other by a rear wall (5),
wherein the two side walls (3, 4) form a channel shape with the rear wall (5),
stacking pawls (1) arranged between the two side walls (3, 4) in the channel shape so that they can pivot over one another,
wherein each stacking pawl (1) is assigned an axle bolt (6) and a linkage bolt (7),
wherein a linkage pin (7) is movably guided within two arcuate elongated holes (8.1, 8.2),
wherein the elongated holes (8.1, 8.2) are each embedded in one of the side walls (3, 4),
and the axle bolt (6) is rotatably mounted between the two side walls (3, 4) and in bores (9.1, 9.2) in the side walls (3, 4),
wherein a return spring (10) is arranged around the axle bolt (6), a first spring leg (11.1) of which presses against the rear wall (5) and a second spring leg (11.2) of which is arranged to push the linkage pin (7) back to a rest position,
wherein
a radial spring (12) connects the linkage pin (7) and the axle bolt (6), and
the linkage pin (7) is arranged to pull toward the axle bolt (6), thereby pulling the linkage pin (7) toward an inner contour (13) of the elongated holes (8.1, 8.2) facing the axle bolt (6), and
wherein the stacking pawl (1) consists of a pawl finger (21) and a guide receptacle (22), wherein the pawl finger (21) is pivotably mounted to the guide receptacle (22) via a pivot pin (15).

2. Stacking column according to claim 1, wherein the inner contour (13) forms an interruption (16) between the rest position of the stacking pawl (1) and a working position of the stacking pawl (1).

3. Stacking column according to claim 1, wherein the inner contour (13) forms an interruption (16) between the rest position of the stacking pawl (1) and a working position of the stacking pawl (1).

4. Stacking column according to claim 2, wherein the interruption (16) forms a protruding bead extending away from the axle bolt (6).

5. Stack column according to claim 1, wherein the pivot pin (15) has a leg spring arranged to press the pawl finger (21) toward the support strip (18).

6. Stacking column according to claim 1, wherein the guide receptacle (22) consists of a base area (23) and two wings (24) arranged at right angles, wherein the wings (24) have two axle bolt bores (25) and two guide bolt slots (26).

7. Stacking column according to claim 1, wherein the guide receptacle (22) forms a support strip (18) under the latch finger (21).

8. Stacking column according to claim 6, wherein the two guide bolt slots (26) are formed parallel to a bend in the base area (23) towards the wings (24).

9. Stacking column according to claim 6, wherein the wings (24) each form a hinge pin bore, wherein the hinge pin (15) is pivotably mounted in and between the wings (24).

10. Stacking column according to claim 1, wherein a second spring strut (11.2) protrudes between the linkage pins (7) and the stacking pawl (1).

11. Stacking column according to claim 1, wherein the inner contour (13) has a substantially arcuate distance of 15 mm to 85 mm from the bores (9.1, 9.2).

12. Stacking column according to claim 1, wherein a further radial spring (19) is provided, wherein the radial spring (12) and the further radial spring (19) flank the return spring (10) at the axle bolt (6) at each end.

13. Stacking column according to claim 1, wherein the inner contour (13) forms further overcoming beads.

14. Stacking column according to claim 1, wherein the stacking pawls (1) are operatively connected to each other via a linkage (20) engaging with each other on the linkage bolt (7).
